(19) United States
(12) Patent Application Publication
(10) Pub. No.: US 2013/0063438 A1
(43) Pub. Date: Mar. 14, 2013

(54) 3-DIMENSIONAL IMAGING USING MICROBUBBLES

(71) Applicants: Richard Gilmour Billett, Lota (AU); James Robert Ward, South Brisbane (AU); Lydia Kay Goh, Morningside (AU)

(72) Inventors: Richard Gilmour Billett, Lota (AU); James Robert Ward, South Brisbane (AU); Lydia Kay Goh, Morningside (AU)

(73) Assignee: EMPIRE TECHNOLOGY DEVELOPMENT LLC, Wilmington, DE (US)

(21) Appl. No.: 13/499,601

(22) PCT Filed: Sep. 12, 2011
(86) PCT No.: PCT/US11/51255

§ 371 Date: Apr. 11, 2012

(51) Int. Cl. G06T 17/00

(52) U.S. Cl. 345/424

(57) ABSTRACT

Technologies and implementations for providing 3-dimensional images are generally disclosed.

### BACKGROUND

Unless otherwise indicated herein, the approaches described in this section are not prior art to the claims in this application and are not admitted to be prior art by inclusion in this section.

Current 3-dimensional imaging techniques, such as stereoscopy, may include creating an illusion of depth for a viewer. Such techniques may provide an illusion of 3-dimensional imagery in a limited viewing angle.

### SUMMARY

The present disclosure describes example systems for providing a 3-dimensional image. Example systems may include a volume of fluid in a transparent container, an array of energy sources configured to provide a plurality of bubbles at selected voxel locations within the volume of fluid, and a controller configured to control the array of energy sources to form the plurality of bubbles at the selected voxel locations to represent the 3-dimensional image.

Example systems may also include a volume of water in a transparent container, an array of energy sources each having two or more sonic transducers configured to provide a plurality of standing waves to form a plurality of bubbles at selected voxel locations within the volume of water, a controller configured to control the array of energy sources to form the plurality of bubbles at the selected voxel locations to represent the 3-dimensional image, and an illumination source configured to provide illumination to the plurality of bubbles.

The present disclosure also describes example methods for providing a 3-dimensional image. Example methods may include providing a volume of fluid in a transparent container, directing an energy impulse from an energy source to a selected voxel location within the volume of fluid to form a bubble at the selected voxel location, the bubble at the selected voxel location being a part of a representation of the 3-dimensional image, and discontinuing the energy impulse to collapse the bubble.

The foregoing summary may be illustrative only and may not be intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is an illustration of a block diagram of an example system that may provide a 3-dimensional image;

FIG. 2 is an illustration of a block diagram of an example system that may provide a 3-dimensional image;

FIG. 3 is an illustration of a flow chart of an example method for providing a 3-dimensional image;

FIG. 4 is an illustration of an example computer program product; and

FIG. 5 is an illustration of a block diagram of an example computing device, all arranged in accordance with at least some embodiments of the present disclosure.

### DETAILED DESCRIPTION

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, devices, systems and computer readable media related to providing 3-dimensional images.

In some examples, 3-dimensional images or video may be provided in a volume of fluid in a transparent container. The 3-dimensional image may be formed by directing an energy impulse or impulses to voxel locations within the fluid. The energy impulse or impulses may cause bubbles to be formed at the voxel locations in a form representing the 3-dimensional image. In some examples, the 3-dimensional image may be maintained as a static image. In some examples, a sequence of 3-dimensional images may be provided to form a 3-dimensional video. In various examples, ambient light may illuminate the bubbles, the bubbles may be collapsed to cause release of visible light via sonoluminescence to provide illumination, the bubbles may transition to and from a plasma state such that visible light may be released during a transition from a higher energy state to a lower energy state, or an illumination source or sources may illuminate the bubbles. In any event, the 3-dimensional image or video may be provided within the volume of liquid. Such embodiments may provide the advantage presenting a substantially realistic 3-dimensional image or video that may be viewed from any angle and/or direction.

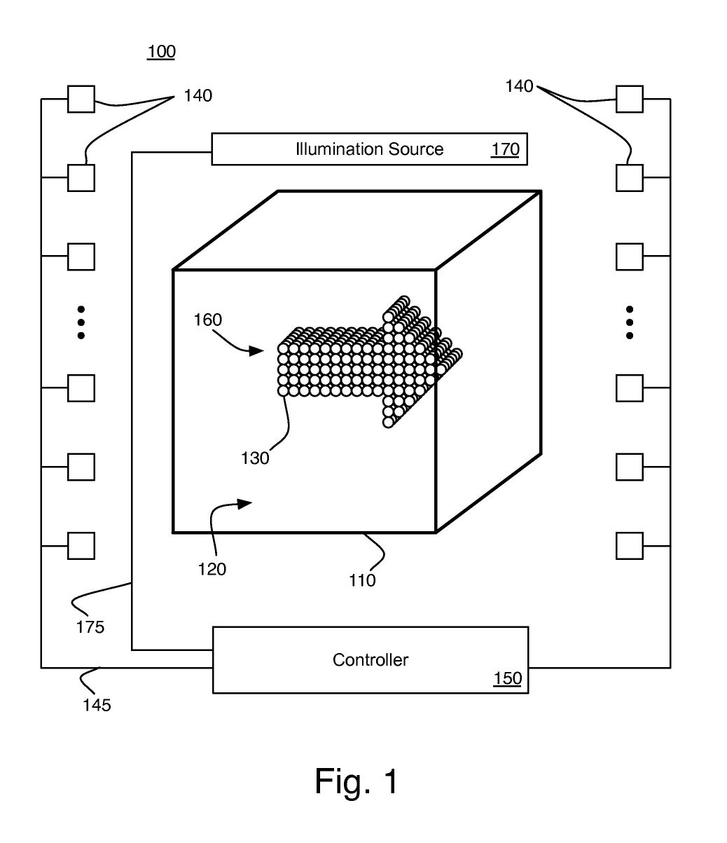

FIG. 1 is an illustration of a block diagram of a system 100 that may provide 3-dimensional images, arranged in accordance with at least some embodiments of the present disclosure. System 100 may include a volume of fluid 120 in a container 110, and an array of energy sources 140 coupled to a controller 150 by a coupler 145. In some examples, controller 150 may be configured to control energy sources 140 to provide bubbles 130 at voxel locations within fluid 120 to form a 3-dimensional image 160. In some examples, controller 150 may control energy sources 140 to maintain 3-dimensional image 160 as a static image. In some examples, controller 150 may control energy sources 140 to form a sequence of 3-dimensional images as a 3-dimensional video. As illustrated in FIG. 1, system 100 may include an optional illumination source 170 coupled to controller 150 by a coupler 175. As illustrated in FIG. 1, 3-dimensional image 160 may be viewable from substantially any angle such that a user may move around 3-dimensional image 160 or multiple users may view 3-dimensional image 160 simultaneously from different sides or angles.

As illustrated in FIG. 1, in some examples, energy sources 140 may substantially surround fluid 120 and container 110. Energy sources 140 may be configured to provide energy impulses to voxel locations within fluid 120 to form bubbles 130 to represent a 3-dimensional image or video. The energy impulses may include any suitable energy impulses, such as, for example, light energy or sonic energy, that may excite fluid 120 to cause cavitation resulting in bubbles 130. In some examples, the energy impulses may be substantially directional such that the location of the formed bubbles may be controlled to represent an image.

In some examples, energy sources 140 may include lasers. In such examples, the lasers may provide impulses of energy in the form of light radiation that may energize the molecules in volume of fluid 120. The absorption of energy may cause inertial cavitation and/or optic cavitation at the voxel locations to form bubbles 130. In some examples, energy sources 140 may include sonic transducers. In such examples, the sonic transducers may provide impulses of energy via sound waves that may cause cavitation at the voxel locations to form bubbles 130.

In some examples, each energy source may couple with another energy source or energy sources such that the two or more energy sources may provide a single bubble. The coupled energy sources may be housed together, located at substantially the same location, or they may be located at different locations around fluid 120 and container 110. Therefore, in some examples, each energy source may be an energy source pair or group, and an energy source array may be an array of energy source pairs or groups. In some examples, the energy sources may be transducer pairs or transducer groups. In some examples, the energy sources may be laser pairs or groups. In some examples, the energy sources may be sonic transducer pairs or groups. In any event, energy impulses from grouped energy sources (or energy sources that may include pairs or groups of lasers or sonic transducers, for example) may provide intersecting energy impulses such that bubbles may be formed at the intersection of the energy impulses. In some examples, bubbles formed at the intersection may be caused by a constructive interference of the intersecting energy impulses. In some examples, bubbles being formed at the intersection may be controlled by an energy impulse from a single energy source being insufficient to form a bubble while in combination intersecting energy impulses from two or more energy sources may have sufficient energy to form a bubble. In some examples, bubbles being formed at an intersection may be caused by a standing wave being formed at the intersection provided by the coupled energy sources such that the standing wave may have sufficient energy to form a bubble. In some examples, bubbles formed using such techniques may be maintained such that they may not collapse until the energy may be discontinued. Such techniques may offer the advantage of providing substantially static bubbles that may not require constant refresh.

In general, any amount of energy sufficient to provide a bubble may be used to form bubbles 130. In some examples, bubbles 130 may be formed by boiling fluid 120 or reducing the localized pressure below the vapor pressure of fluid 120. In some examples, as is discussed herein, fluid 120 may be water. In such examples, the energy required to vaporize water may be about 2,260 joules per gram. In some examples, a bubble may include about 1 microgram of water such that a bubble may require about 2.26 millijoules to vaporize. In some examples, a display frequency refresh rate may be in the range of about 1,000 hertz. In such examples, the power required to maintain a bubble at a voxel location may be about 2.26 watts. In some examples, the operation of system 100 may require about 2.26 kilowatts. As discussed, in some examples, the fluid may be water and the energy impulse directed to provide a bubble may be about 2.26 millijoules at room temperature and standard pressure. In some examples, the energy impulse directed to provide a bubble may be in the range of about 1.5 to 3 millijoules. In some examples, the energy impulse directed to provide a bubble may be in the range of about 3 to 4 millijoules. In some examples, the energy impulse directed to provide a bubble may be in the range of about 4 to 6 millijoules.

In general, system 100 may include any number of energy sources 140. In some examples, each energy source, pair of energy sources or group of energy sources may control a single voxel location. In some examples, the number of energy sources, pairs of energy sources or groups of energy sources may be less than the number of voxel locations. In some examples, the energy sources may be directionally controlled to provide bubbles at any voxel location or at a predefined subset of voxel locations. In some examples, the energy sources, paired energy sources or groups or energy sources may scan the fluid to form bubbles at many voxel locations throughout a scan. As is discussed herein, as bubbles collapse, the scan may refresh the bubbles at a substantially high frequency such that the user may not be able to perceive the refresh. Instead, the user may perceive a substantially static and/or smooth 3-dimensional video. In some examples, the energy sources may include a devices or devices to direct the energy impulses. In some examples, the directional device or devices may include mirrors, lenses, electric motors, control circuitry, or the like. In some examples, controller 150 may control the direction, on/off state, power level, or the like of each energy source to form 3-dimensional image 160.

As discussed, system 100 may include a container 110. In some examples, container 110 may be a substantially transparent container such that 3-dimensional image 160 may be viewed by a user. As discussed, in some examples, energy sources 140 may be lasers or pairs of lasers and, in such examples, container 110 may be substantially transparent for the wavelength of the employed laser. As discussed, in some examples, energy sources 140 may be sonic transducers, pairs of sonic transducers or groups of sonic transducers, and, in such examples, the shape and material of container 110 may include a material that may not substantially hinder the transduction of the sound waves transmitted by the sonic transducers. In some examples, container 110 may be made of glass. In some examples, container 110 may be made of a substantially transparent plastic such as, for example, an acrylic, a polycarbonate, a Lexan, a butyrate, or the like.

In general, container 110 may be of any suitable size and/or shape such that it may contain volume of fluid 120 sufficient for the formation of 3-dimensional image 160. In some examples, container 110 may be in the shape of a sphere, a cube, a cuboid, a dodecahedron, a spherical polyhedron, a cylinder, or the like. In some examples, container 110 may have a volume in the range of about 0.02 cubic meters to 0.1 cubic meters. In some examples, container 110 may have a volume in the range of about 0.1 cubic meters to 5 cubic meters. In some examples, container 110 may have a volume in the range of about 5 cubic meters to 40 cubic meters.

FIG. 1 illustrates bubbles 130 represented as substantially large for the sake of clarity of presentation. As will be appreciated, in some examples, bubbles 130 may be substantially small such that they may not be resolvable as bubbles by the human eye from a standard viewing distance and such that 3-dimensional image 160 may appear as a substantially continuous image to a user, similar to a display's pixels defining an image for a viewer. In some examples, bubbles 130 may have a diameter in the range of about 0.003 to 0.005 mm. In some examples, bubbles 130 may have a diameter in the range of about 0.005 to 0.01 mm. In some examples, bubbles 130 may have a diameter in the range of about 0.01 to 0.02 mm. In some examples, bubbles 130 may be considered microbubbles. In FIG. 1, 3-dimensional image 160 illustrates an arrow. As will be appreciated, any 3-dimensional shape may be rendered by system 100.

In general, system 100 may include any number of voxel locations such that 3-dimensional image 160 may be formed for viewing by a user. In some examples, system 100 may include 100,000 to 1 million voxels. In some examples, system 100 may include 1 million to 1 billion voxels. In some examples, system 100 may include 1 billion to 250 billion voxels. In some examples, system 100 may include 250 billion to 1 trillion voxels. As will be appreciated, in some examples, only voxels related to surface voxels may be rendered for 3-dimensional image 160 such that of the many possible voxels, only a fraction of those may be rendered as bubbles during various image presentations.

As discussed, energy sources 140 may provide energy impulses at voxel locations within fluid 120 to produce bubbles 130. In general, fluid 120 may include any suitable material that may allow for the formation of substantially stable bubbles 130 such that the bubbles may be non-moving and/or non-collapsing, and for the viewing or 3-dimensional image 160. In some examples, fluid 120 may be water. In some examples, fluid 120 may include a dye and fluid 120 may be a dyed fluid. In some examples, fluid 120 may include a dyed water. In some examples, fluid 120 may include a surfactant. In some examples, the quality, formation energy, or persistence characteristics of bubbles may be related to the viscosity of fluid 120. In some examples, the viscosity of fluid 120 may be in the range of about 0.3 to 0.75 millipascal-seconds. In some examples, the viscosity of fluid 120 may be in the range of about 0.75 to 1 millipascal-seconds. In some examples, the viscosity of fluid 120 may be in the range of about 1 to 1.5 millipascal-seconds.

In general, fluid 120 may be maintained at any temperature or pressure such that bubbles 130 may be formed to produce 3-dimensional image 160. In some examples, fluid 120 may be allowed to remain at room temperature (about 19 to 25° C.) and/or pressure (about 101.3 kilopascals). In some examples, fluid 120 may be maintained at a temperature in the range of about 15 to 19° C. In some examples, fluid 120 may be maintained at a temperature in the range of about 20 to 25° C. In some examples, fluid 120 may be maintained at a temperature in the range of about 25 to 35° C. In some examples, fluid 120 may be maintained at a higher temperature. The temperature of fluid 120 may be provided using heaters, cooling systems, related control systems, or the like, which are not shown for the sake of clarity of presentation. In some examples, fluid 120 may be held under a vacuum to facilitate bubble formation. In some examples, fluid 120 may be held under a vacuum of about 100 to 50 kilopascals. In some examples, fluid 120 may be held under a vacuum of about 50 to 10 kilopascals. In some examples, fluid 120 may be held under a vacuum of about 10 to 5 kilopascals. The pressure of fluid 120 may be provided using pumps, valves, related control systems, or the like, which are not shown for the sake of clarity of presentation. In some examples, the temperature and pressure may be monitored and/or controlled by controller 150.

As discussed, in some examples, system 100 may include an illumination source 170. Illumination source 170 may be configured to provide illumination that may reflect off the inside surfaces of bubbles 130. In some examples, illumination from illumination source may cause or facilitate the collapse of bubbles 130. In some examples, a photon of light that may bounce off a surface of bubble 130 may cause the bubble to implode. In some examples, illumination source 170 may provide a broad, general illumination for 3-dimensional image 160 similar to a back light in a 2-dimensional display. In such examples, illumination source 170 may include any suitable light source such as one or more light bulbs, one or more monochromatic illumination sources, one or more lasers, one or more light emitting diodes, or the like. Illumination source 270 may be arranged with respect to fluid 120 and container 110 in any manner suitable to provide illumination to 3-dimensional image 160. As shown, in some examples, illumination source 170 may be above fluid 120 and container 110. In some examples, illumination source 170 may be around the sides of fluid 120 and container 110. In some examples, illumination source 170 may be below fluid 120 and container 110. In some examples, illumination source 170 may be above, below, and around the sides of fluid 120 and container 110. In some examples, illumination from a single illumination source 170 may be directed about fluid 120 using mirrors or the like. Illumination source 170 may provide any light suitable for illuminating 3-dimensional image 160. In some examples, illumination source 170 may provide monochromatic light. In some examples, illumination source 170 may provide different colors of light under control of controller 150. In some examples, illumination source 170 may vary the color of light provided to 3-dimensional image 160 under the control of controller 150.

As discussed herein, in some examples, system 100 may not include an illumination source or sources. In some examples, in system 100, illumination of bubbles 130 may include illumination by ambient light. In some examples, illumination may be provided by collapsing bubbles 130 such that visible light may be released via sonoluminescence. In some examples, illumination may be provided by bubbles 130 transitioning to and from a plasma state such that visible light may be released during a transition from a higher energy state to a lower energy state.

As shown in FIG. 1, system 100 may include couplers 145, 175 to couple controller 150 to energy sources 140 and illumination source 170, respectively. In general, couplers 145, 175 may include any suitable coupler that may allow communication between controller 150 and energy sources 140 and between controller and illumination source 170. In some examples, couplers 145, 175 may include a cable or cables. In some examples, couplers 145, 175 may include a wired network. In some examples, couplers 145, 175 may include a wireless network.

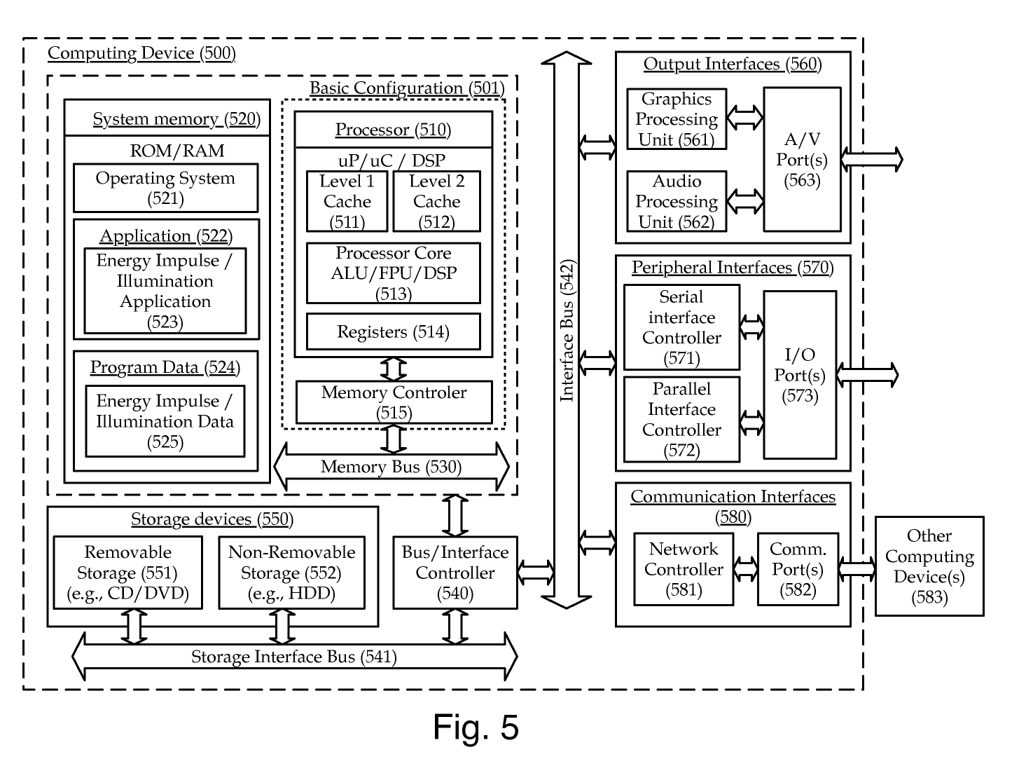

As discussed, controller 150 may be configured to control energy sources 140 and/or optional illumination source 170. In general, controller 150 may include any suitable device or devices that may control energy sources 140. In some examples, controller 150 may include an integrated device and energy sources 140 and/or optional illumination source 170 may be controlled using a hardware implementation, a firmware implementation, a software implementation, or any combination thereof. In some examples, controller 150 may include a general purpose computing device such as, for example, a server, a computer, a laptop computer, a handheld device, or the like. As is discussed herein, controller 150 may implemented as a device described with respect to FIG. 5 and controller 150 may include any or all of the discussed components. Data related to 3-dimensional image 160, other 3-dimensional images, or 3-dimensional video may be provided to controller 150 in any suitable manner such as, for example, by storage in memory of controller 150, by provision on a memory device such as a solid state memory device, a memory disk, or the like, or by communication to controller 150 over a wired or wireless network, or the like.

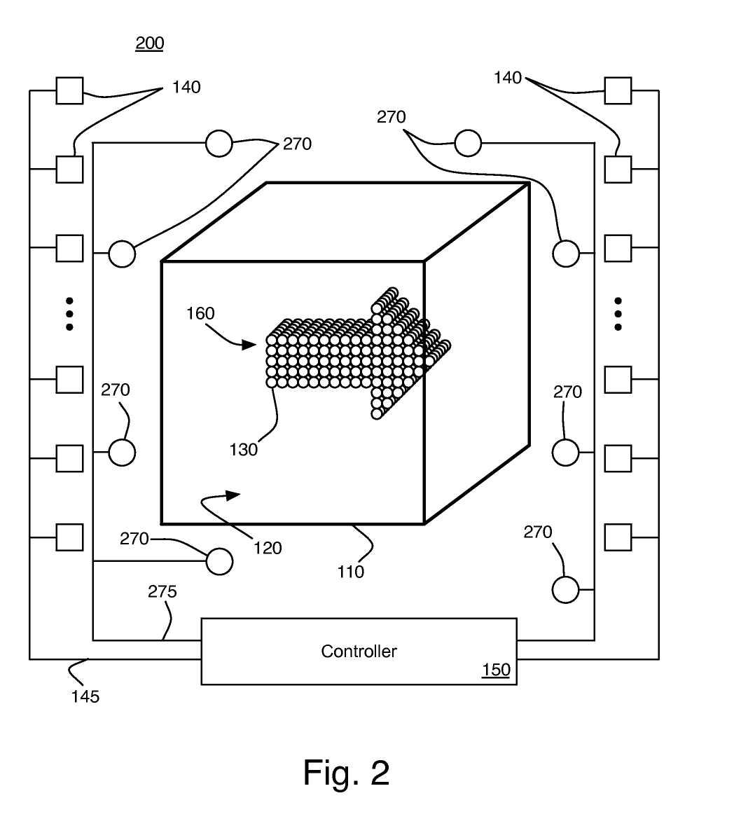

FIG. 2 is an illustration of a block diagram of a system 200 that may provide 3-dimensional images, arranged in accordance with at least some embodiments of the present disclosure. System 200 may include a fluid 120 in a container 110, an array of energy sources 140 coupled to a controller 150 by a coupler 145, and one or more illumination sources 270 coupled to controller 150 by a coupler 275. In some examples, controller 150 may be configured to control energy sources 140 and illumination sources 270 to form and illuminate bubbles 130 at voxel locations within fluid 120 to form and illuminate 3-dimensional image 160.

In general, system 200 may include fluid 120 in container 110, energy sources 140 coupled by coupler 145 to controller 150, which may include any of the example materials, arrangements, and/or implementations discussed with respect to FIG. 1 and elsewhere herein. System 200 may also include illumination sources 270. As illustrated in FIG. 2, illumination sources 270 may substantially surround fluid 120 and container 110. Illumination sources 270 may be configured to provide illumination to bubbles 130. The illumination provided by illumination sources 270 may include any suitable illumination. In some examples, the illumination provided to each bubble may be monochrome illumination. In some examples, the illumination provided to each bubble may be substantially the same intensity. In some examples, the color and/or intensity of the illumination provided to each bubble may be region and/or bubble specific to enhance the appearance of 3-dimensional image 160. In some examples, the illumination may include an image that may be wrapped onto 3-dimensional image 160 to enhance 3-dimensional image 160. For example, bubbles 130 may provide the shape and/or texture of 3-dimensional image 160 and the illumination provided by illumination sources 270 may provide the image, coloring, and/or intensity of 3-dimensional image 160.

In general, illumination sources 270 may include any suitable sources of illumination. In some examples, illumination sources 270 may include projectors, lights, light emitting diodes, lasers, or the like. In some examples, illumination sources 270 may provide monochromatic light. In some examples, illumination sources 270 may provide a substantially constant intensity of light. In some examples, illumination sources 270 may provide any color and/or intensity of light. In some examples, illumination sources 270 may provide images to be projected on and/or wrapped around 3-dimensional image 160.

In general, any number of illumination sources 270 may be provided such that 3-dimensional image 160 may be illuminated. As shown, in some examples, four illumination sources may be provided. In some examples, 1 to 10 illumination sources may be provided. As shown, in some examples, container 110 may be a cube. In such examples, 6 illumination sources may be provided with 1 illumination source for each face of the cube. As discussed, in some examples, illumination sources 270 may include projectors. In such examples, the image or images may be projected and wrapped onto the surface of 3-dimensional image 160. In some examples, the image or images may be projected and wrapped onto 3-dimensional image 160 using texture mapping techniques.

In some examples, each illumination source may provide illumination for a single voxel location. In some examples, illumination sources 270 may be directionally controlled to provide illumination at any voxel location, surface area of 3-dimensional image 160, or at a predefined subset of voxel locations. In such examples, illumination sources 270 may provide focused beams of light or laser beams to bubbles 130. In some examples, illumination sources 270 may scan across 3-dimensional image 160 and refresh such that the viewer perceives a substantially constant illumination of 3-dimensional image 160. In such examples, illumination sources 270 may include a direction devices or devices to direct the illumination. In some examples, the directional device or devices may include mirrors, lenses, electric motors, control circuitry, or the like. In some examples, controller 150 may control the direction, on/off state, color, intensity level, or the like of each illumination source. As discussed herein, in some examples, illumination from illumination sources 270 may cause or facilitate the collapse of bubbles 130.

As shown in FIG. 2, system 200 may include coupler 275 to couple controller 150 to illumination sources 270. In general, coupler 275 may include any suitable coupler that may allow communication between controller 150 and illumination sources 270. In some examples, coupler 275 may include a cable or cables. In some examples, coupler 275 may include a wired network. In some examples, coupler 275 may include a wireless network.

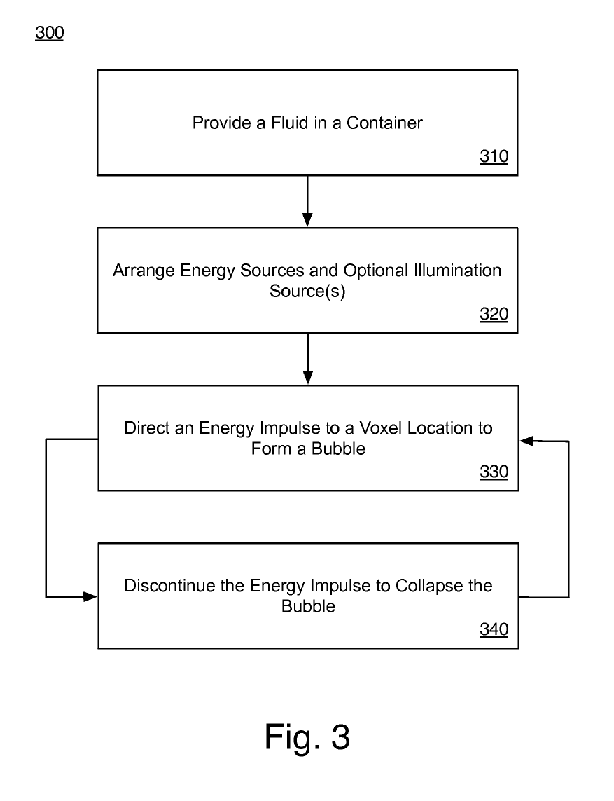

FIG. 3 is an illustration of a block diagram of an example method 300 for providing a 3-dimensional image or video, arranged in accordance with at least some embodiments of the present disclosure. In general, the method of FIG. 3 may be performed by any suitable system, device or devices such as system 100, system 200, or any system, device or devices discussed herein. Method 300 sets forth various functional blocks or actions that may be described as processing steps, functional operations, events and/or acts, etc., which may be performed by hardware, software, and/or firmware. Numerous alternatives to the functional blocks shown in FIG. 3 may be practiced in various implementations. For example, intervening actions not shown in FIG. 3 and/or additional actions not shown in FIG. 3 may be employed and/or some of the actions shown in FIG. 3 may be eliminated, without departing from the scope of claimed subject matter. Method 300 may include one or more of functional operations as indicated by one or more of blocks 310, 320, 330 and/or 340. The process of method 300 may begin at block 310.

At block 310, “Provide a Fluid in a Container”, a fluid may be provided in a container and arranged such that a 3-dimensional image may be formed by bubbles formed at voxel locations in the fluid. In general, the fluid and the container may include any of the materials and/or implementations discussed herein. In some examples, the fluid may be fluid 120 and the container may be container 110 as discussed with respect to FIGS. 1 and 2. Method 300 may continue at block 320.

At block 320, “Arrange Energy Sources and Optional Illumination Source(s)”, an array of energy sources and one or more optional illumination sources may be arranged with respect to the fluid in the container to provide energy impulses to voxel locations in the fluid to form a 3-dimensional image. In general, the energy sources and optional illumination source or sources may include any of the devices and/or implementations discussed herein. In some examples, the energy sources may be energy sources 140 and the illumination source or sources may be illumination source 170 and/or illumination sources 270 as discussed with respect to FIGS. 1 and 2. Method 300 may continue at block 330.

At block 330, “Direct an Energy Impulse to a Voxel Location to Form a Bubble”, an energy impulse or impulses may be directed to a voxel location in the fluid to form a bubble. In some examples, the bubble formed at the selected voxel location may be a part of a representation of the 3-dimensional image. In general, the energy impulse or impulses may be directed to the voxel location in any suitable manner as discussed herein. In some examples, the bubble may be formed under the control of a controller using an energy source or paired energy sources. In some examples, the bubble may be formed from an energy impulse from a single energy source. In some examples, the bubble may be formed from an intersection of energy impulses from a pair of energy sources. In such examples, forming the bubble may include directing a first energy impulse from a first energy source to the selected voxel location and directing a second energy impulse from a second energy source to the selected voxel location such that the energy impulse and the second energy impulse may intersect at the voxel location to form a constructive interference that may form the bubble at the selected voxel location. In some examples, the bubble may be formed from an intersection of energy impulses from a group of energy sources. In such examples, forming the bubble may include directing energy impulses from three or more energy sources to the selected voxel location such that the energy impulses may intersect at the voxel location to form a constructive interference that may form the bubble at the selected voxel location. As discussed herein, in some examples, the bubbles may be illuminated and in some examples, illumination may not be provided. Method 300 may continue at block 340.

At block 340, “Discontinue the Energy Impulse to Collapse the Bubble”, the energy impulse may be discontinued to collapse the formed bubble. In some examples, the collapsed bubble may cause illumination of the bubble via sonoluminescence, as discussed herein. As discussed, in some examples, the bubble collapse may be caused or facilitated by a provided illumination. As shown, method 300 may cycle between block 330 and 340 such that bubbles may be repeatedly generated to form a 3-dimensional image. In some examples, the bubble may be reformed at the same location to produce, for a viewer, an illusion that the bubble may be constant and a 3-dimensional image may be static. In some examples, the refresh rate of the bubble may be such that it may be refreshed at a frequency that may be greater than the persistence of vision of a viewer. For example, a persistence of vision may provide, for a viewer, an after-image that may persist for about 0.04 seconds. Therefore, a refresh frequency of the bubble may be greater than about 25 hertz to provide to a viewer a simulation that the bubble may be constant. In some examples, the refresh frequency may be in the range of about 200 to 400 hertz. In some examples, the refresh frequency may be in the range of about 400 to 800 hertz. In some examples, the refresh frequency may be in the range of about 800 to 1200 hertz.

In some examples, the image may have changed such that the bubble may not need to be refreshed at the same location. In such examples, method 300 may continue at block 330 with a bubble being formed at a new voxel location. As will be appreciated, the method of blocks 330 and 340 may be performed and repeated for any number of bubbles to form a 3-dimensional image and/or a 3-dimensional video.

As discussed, in some examples, the bubble formed at block 330 may be maintained such that it may not collapse. In such examples, the formed bubble may be maintained by providing substantially continuous energy impulses from the energy source or pair of energy sources. In such examples, method 300 may continue to block 340 when the bubble may no longer be desired. Method 300 may then cycle back to block 330 such that a bubble may be formed at a new voxel location. As will be appreciated, in such persistent bubble applications, the operations of blocks 330 and 340 may be performed and repeated for any number of bubbles to form a 3-dimensional image and/or a 3-dimensional video. Method 300 may end when a 3-dimensional image may no longer be desired.

The methods, devices, systems and computer readable media related to providing 3-dimensional images discussed herein may facilitate a wide variety of images including the 3-dimensional images and/or video being viewable from substantially any angle. The formed images may be used for substantially any purpose and in any application or applications such as, for example, entertainment, communications, gaming, or engineering applications such as rapid prototyping applications, and accordingly, not limited in this respect.

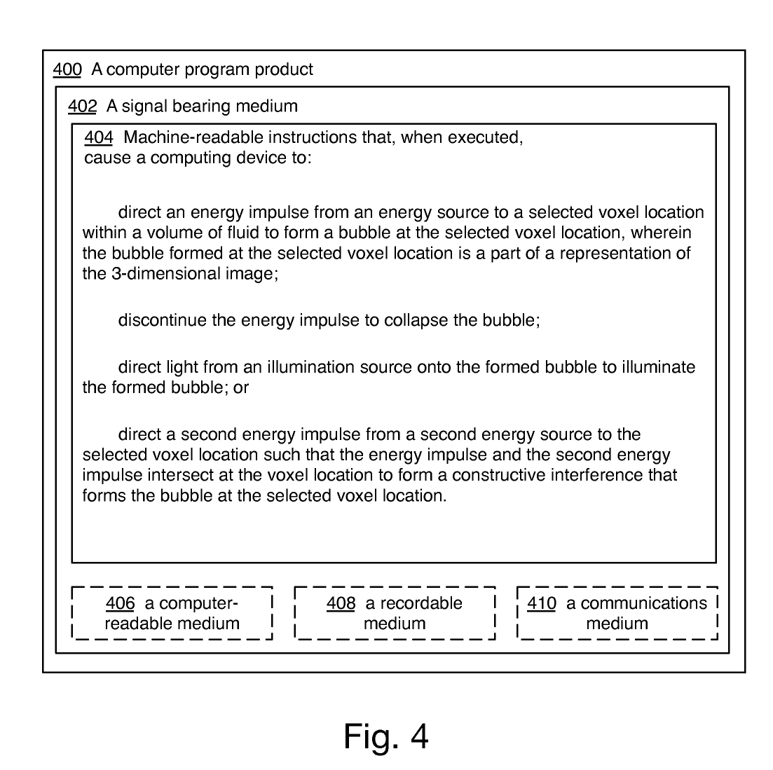

FIG. 4 illustrates an example computer program product 400, arranged in accordance with at least some embodiments of the present disclosure. Computer program product 400 may include machine readable non-transitory medium having stored therein a plurality of instructions that, when executed, cause the machine to provide device power management according to the processes and methods discussed herein. Computer program product 400 may include a signal bearing medium 402. Signal bearing medium 402 may include one or more machine-readable instructions 404, which, when executed by one or more processors, may operatively enable a computing device to provide the functionality described herein. In various examples, some or all of the machine-readable instructions may be used by the devices discussed herein.

In some implementations, signal bearing medium 402 may encompass a computer-readable medium 406, such as, but not limited to, a hard disk drive, a Compact Disc (CD), a Digital Versatile Disk (DVD), a digital tape, memory, etc. In some implementations, signal bearing medium 402 may encompass a recordable medium 408, such as, but not limited to, memory, read/write (R/W) CDs, R/W DVDs, etc. In some implementations, signal bearing medium 402 may encompass a communications medium 410, such as, but not limited to, a digital and/or an analog communication medium (e.g., a fiber optic cable, a waveguide, a wired communication link, a wireless communication link, etc.). In some examples, signal bearing medium 402 may encompass a machine readable non-transitory medium.

FIG. 5 is a block diagram illustrating an example computing device 500, arranged in accordance with at least some embodiments of the present disclosure. In various examples, computing device 500 may be configured to control a 3-dimensional image forming system as discussed herein. In various examples, computing device 500 may be implemented as a controller as discussed herein and, in particular, with respect to FIGS. 1 and 2. In one example basic configuration 501, computing device 500 may include one or more processors 510 and system memory 520. A memory bus 530 can be used for communicating between the processor 510 and the system memory 520.

Depending on the desired configuration, processor 510 may be of any type including but not limited to a microprocessor (μP), a microcontroller (μC), a digital signal processor (DSP), or any combination thereof. Processor 510 can include one or more levels of caching, such as a level one cache 511 and a level two cache 512, a processor core 513, and registers 514. The processor core 513 can include an arithmetic logic unit (ALU), a floating point unit (FPU), a digital signal processing core (DSP Core), or any combination thereof. A memory controller 515 can also be used with the processor 510, or in some implementations the memory controller 515 can be an internal part of the processor 510.

Depending on the desired configuration, the system memory 520 may be of any type including but not limited to volatile memory (such as RAM), non-volatile memory (such as ROM, flash memory, etc.) or any combination thereof. System memory 520 may include an operating system 521, one or more applications 522, and program data 524. Application 522 may include energy impulse and/or illumination application 523 that can be arranged to perform the functions, actions, and/or operations as described herein including the functional blocks, actions, and/or operations described herein. Program Data 524 may include energy impulse and/or illumination data 525 for use with battery management application 523. In some example embodiments, application 522 may be arranged to operate with program data 524 on an operating system 521. This described basic configuration is illustrated in FIG. 5 by those components within dashed line 501.

Computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The data storage devices 550 may be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of device 500.

Computing device 500 may also include an interface bus 542 for facilitating communication from various interface devices (e.g., output interfaces, peripheral interfaces, and communication interfaces) to the basic configuration 501 via the bus/interface controller 540. Example output interfaces 560 may include a graphics processing unit 561 and an audio processing unit 562, which may be configured to communicate to various external devices such as a display or speakers via one or more NV ports 563. Example peripheral interfaces 570 may include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication interface 580 includes a network controller 581, which may be arranged to facilitate communications with one or more other computing devices 583 over a network communication via one or more communication ports 582. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 500 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. Computing device 500 may also be implemented as a personal computer including both laptop computer and non-laptop computer configurations. In addition, computing device 500 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communication link, a wireless communication link, etc.).

The herein described subject matter sometimes illustrates different components contained within, or connected with, different other components. It is to be understood that such depicted architectures are merely examples and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain example techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A system for providing a 3-dimensional image comprising:
a volume of fluid in a transparent container;
an array of energy sources configured to provide a plurality of bubbles at selected voxel locations within the volume of fluid; and
a controller configured to control the array of energy sources to form the plurality of bubbles at the selected voxel locations to represent the 3-dimensional image.

2. The system of claim 1, further comprising:
an illumination source configured to provide illumination to the plurality of bubbles.

3. The system of claim 2, wherein the illumination source is configured to provide a directed illumination to each of the plurality of bubbles.

4. The system of claim 2, wherein the illumination source comprises at least one of a monochromatic illumination source or a laser.

5. The system of claim 1, wherein the array of energy sources comprises at least one of an array of lasers or an array of sonic transducers.

6. The system of claim 1, wherein the array of energy sources each have two or more sonic transducers configured to provide standing waves at the selected voxel locations.

7. The system of claim 1, wherein the fluid comprises at least one of water or a dyed fluid.

8. The system of claim 1, wherein the transparent container comprises at least one of the following shapes: a sphere, a cube, a cuboid, a dodecahedron, a spherical polyhedron, or a cylinder.

9. A system for providing a 3-dimensional image comprising:
a volume of water in a transparent container;
an array of energy sources each having two or more sonic transducers configured to provide a plurality of standing waves to form a plurality of bubbles at selected voxel locations within the volume of water;
a controller configured to control the array of energy sources to form the plurality of bubbles at the selected voxel locations to represent the 3-dimensional image; and
an illumination source configured to provide illumination to the plurality of bubbles.

10. The system of claim 9, wherein the illumination source is configured to provide a directed illumination to each of the formed bubbles.

11. The system of claim 9, wherein the volume further comprises a dye.

12. The system of claim 9, wherein the transparent container comprises at least one of the following shapes: a sphere, a cube, a cuboid, a dodecahedron, a spherical polyhedron, or a cylinder.

13. A method for providing a 3-dimensional image comprising:
providing a volume of fluid in a transparent container;
directing an energy impulse from an energy source to a selected voxel location within the volume of fluid to form a bubble at the selected voxel location, wherein the bubble formed at the selected voxel location is a part of a representation of the 3-dimensional image; and
discontinuing the energy impulse to collapse the bubble.

14. The method of claim 13, wherein the bubble collapsing causes a release of visible light via sonoluminescence.

15. The method of claim 13, further comprising:
directing light from an illumination source onto the formed bubble to illuminate the formed bubble.

16. The method of claim 13, wherein the formed bubble is illuminated with ambient light.

17. The method of claim 13, wherein the fluid comprises water and wherein the directed energy impulse is in the range of about 1.5 to 3 millijoules.

18. The method of claim 13, wherein the directing the energy impulse and the discontinuing the energy impulse are repeated at the voxel location at a refresh frequency in the range of about 200 to 1000 hertz to form a perceptively persistent bubble at the selected voxel location.

19. The method of claim 13, wherein the energy source comprises at least one of a laser or a sonic transducer.

20. The method of claim 13, further comprising:
directing a second energy impulse from a second energy source to the selected voxel location such that the energy impulse and the second energy impulse intersect at the voxel location to form a constructive interference that forms the bubble at the selected voxel location.
